(19) United States
(12) Patent Application Publication
(10) Pub. No.: US 2022/0165099 A1
(43) Pub. Date: May 26, 2022

(54) SYSTEM AND METHOD FOR ACCOUNTING FOR A CIVILIAN AT A SITE AND SYSTEM AND METHOD FOR PROVIDING PERSONNEL WITH INFORMATION ABOUT A SITE OR EMERGENCY SITE

(71) Applicant: Salamander Technologies, LLC, Wayzata, MN (US)

(72) Inventor: Robert F. Riess, Wayzata, MN (US)

(21) Appl. No.: 17/533,948

(22) Filed: Nov. 23, 2021

Related U.S. Application Data
(60) Provisional application No. 63/117,361, filed on Nov. 23, 2020.

(51) Int. Cl. G07C 1/12; H04W 4/029; G06F 16/21

(52) U.S. Cl. CPC G07C 1/12; G06F 16/21; H04W 4/029

(57) ABSTRACT

A civilian accountability system accounting for civilians on-site or at a remote site that is interoperable with a personnel (first responder) accountability system. The civilian accountability system includes an information receiving device, a processor, and a display. The information receiving device is provided for receiving information from a data storage device carried by the civilian or from the civilian directly. The received information pertains to the civilian, and may include identification, qualification, and/or medical information. Upon receiving the data, the system subsequently stores and displays the received information. This system may also be used to receive information regarding a site.

### PRIORITY INFORMATION

This application claims priority to U.S. Provisional Patent Application No. 63/117,361, filed Nov. 23, 2020, the entirety of which is incorporated herein.

### BACKGROUND

The present disclosure relates to a system and method for accounting for civilian at a site. More particularly, the present disclosure relates to a system and method for accounting for civilians in case of an emergency.

Nearly every emergency response department faces the problems of accounting for civilians at a scene of an emergency, having an accurate and readily accessible medical history for any civilian that is injured, and knowing where civilians are before arrive on the scene.

Presently, to account for people at the scene of an emergency, emergency response will likely follow, home grown accountability processes, ad hoc systems, and even pen and paper logs to account for all people. As a result, time is lost during the accountability process.

### SUMMARY

In general, this disclosure is directed to a civilian accountability system of that easily and rapidly provides personnel, incident commander, first responders, and medical personnel the information they require to perform their respective tasks in a safe and effective manner without requiring personnel, and first responders to maintain, transport, and sort through numerous documents. Further, at a site where a system is in place for tracking the location of civilians within the site, the site information may identify whether any individuals are trapped within the site and may provide their location within the site. Thus, by allowing the first responders on the scene to obtain this valuable information, the first responders subsequently arriving at the scene may be provided with information that will increase their safety, improve their ability resolve the situation.

First responders would benefit by scanning of the QR code, to not only be able to log the civilian on-site, but to be able to see additional civilian details. Also, with the scan of the QR code, be able to assign civilian in specific set assignments to account the location for both real time and historical purposes. First responders benefit by scanning a civilian QR code, which contains variable information about the resource, logs the civilian on-site, and displays additional resource details.

In view of inherent danger during a situation, the odds that a civilians shall receive medical attention may be higher. Therefore, it would be desirable to maintain a medical history of each civilian on-site. However, maintaining and transporting documentation having this information presents additional burdens upon first responders. Overall, with this civilian accountability system in place, first responders can then join the civilian event with the first responder event to create a common operating picture to show all resources.

Additionally, the present disclosure allows an incident commander to log in and obtain visibility on each civilian that has been scanned giving them an overall snapshot of the situation at all times. When we say overall snapshot, the command center is able to see both the resources from the first responders and the resources of the civilians all in one common operating picture.

Another aspect of the personnel accountability system of the present disclosure is that it provides medical information associated with a civilian to medical personnel at the scene without requiring the first responders or the medical personnel to maintain this medical information. The medical information may include the civilian medical history, allergies, medications being taken, hospital preference, insurance information, doctor's name and telephone number, and a list of individuals to contact in case of an emergency.

Additional features and advantages of the disclosure will be set forth in part in the description which follows and in part will be apparent from the description, or may be learned by practice of the disclosure.

To achieve these and other advantages, and in accordance with the purpose of the disclosure as embodied and broadly described herein, the civilian accountability method of the present disclosure includes the steps of transporting a portable information receiving device to a site and using it to receive machine-recognizable information that is associated with a person on site and

includes the person's identification, in order to log that person into the computer, determining the person's details, and recording in the computer location to which the person is assigned. Such machine-recognizable information may be presented using radio frequency identification (RF I.D.), infrared, satellite, or sonic/voice recognition technologies, touch memory devices, smart cards, magnetic stripes, or one- or two-dimensional bar codes.

The features and advantages of the disclosure may be realized and obtained by means of the instrumentalities and combinations particularly pointed out in the written description and claims hereof, as well as the appended drawings.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a computer hardware system that may be utilized in implementing the present disclosure;

FIG. 2 is a flow diagram showing the overall flow of events that would typically occur at the scene of an emergency as a result of implementing the present disclosure;

FIG. 3 is a flow diagram showing the flow of events that would typically occur to obtain site information using the present disclosure;

FIG. 4 is a flow diagram showing the flow of events that would typically occur to log in personnel using the present disclosure;

FIG. 5 is a flow diagram showing the flow of events that would typically occur to dispatch personnel using the present disclosure;

FIG. 6 is a flow diagram showing the flow of events that would typically occur to combine two incidents creating a common operating picture using the present disclosure;

FIG. 7 is a flow diagram showing the flow of events that would typically occur to obtain medical information using the present disclosure;

FIG. 8 is a graphic illustration of an exemplary display screen showing medical information that may be provided in a medical information tag;

FIG. 9 is a perspective illustration of an implementation of the present disclosure according to a first embodiment;

FIG. 10 is a perspective illustration of an implementation of the present disclosure according to a second embodiment;

FIG. 11 is a perspective illustration of an implementation of the present disclosure according to a third embodiment;

FIG. 12 is a perspective illustration of an implementation of the present disclosure according to a fourth embodiment; and

FIG. 13 is a perspective illustration of an implementation of the present disclosure according to a fifth embodiment.

### DETAILED DESCRIPTION

In U.S. Pat. No. 5,596,652, which is incorporated herein by reference, an implementation of a personnel accountability system is described that utilizes machine-readable data, such as two-dimensional bar codes, carried by the personnel to store data representing information pertaining to the personnel. Although the use of two-dimensional bar codes as the medium for storing the machine-readable data represents the an embodiment when used for tracking civilians, other alternative implementations and embodiments of a civilian accountability system have been found to be suitable for use in civilian accountability and, perhaps have advantages over other applications such as accounting for construction workers, military personnel, forest rangers, workers on a floating oil/gas platform, etc. The alternative implementations are described below.

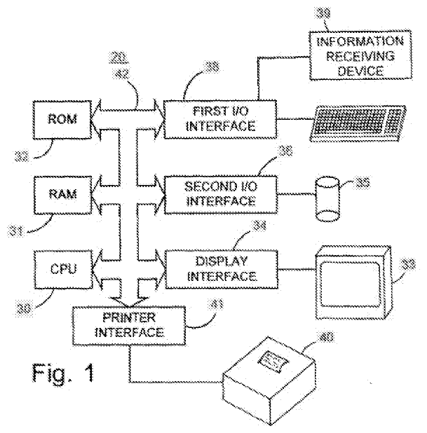

FIG. 1 shows an example of one computer hardware system 20 that may be used, in whole or in part, to implement the various embodiments of the personnel accountability system of the present disclosure. As shown in FIG. 1, computer hardware system 20 includes a central processing unit (CPU) 30, a random access memory (RAM) 31, a read only memory (ROM) 32, a display monitor 33, a display interface 34 connected to display monitor 33, a data storage device 35, a first input/output (I/O) interface 36 connected to data storage device 35, a keyboard 37, a second I/O interface 38 connected to keyboard 37, an information receiving device 39 connected to second I/O interface 38, a printer 40, a printer interface 41 connected to printer 40, and a system bus 42 for interconnecting CPU 30, RAM 31, ROM 32, display interface 34, first I/O interface 36, second I/O interface 38, and printer interface 41. As described below, information receiver 39 may take any appropriate form for receiving data from the particular form of data storage device used for the particular embodiment or for receiving machine-recognizable information that may be processed by a computer. Data storage device 35 can be a computer hard disk drive.

As will be apparent to those of ordinary skill in the art, with the possible exception of information receiver 39 and printer 40, the components of computer hardware system 20 may be incorporated into a personal computer and can be incorporated into a portable or laptop computer. However, as will become apparent from the following description of the present disclosure, certain components of computer hardware system 20 may be eliminated depending upon the manner in which it is used within the confines of the present disclosure. For example, if computer hardware system 20 were used solely for producing and storing the data carried by the civilian, information receiver 39 may be eliminated. On the other hand, if computer hardware system 20 were used solely for receiving data and displaying the data contained therein, keyboard 37 may be eliminated and printer 40 would become optional unless one wished to print out information displayed on display monitor 33. By eliminating keyboard 37 and/or printer 40, computer hardware system 20 may be implemented in a very portable, small integral device.

The particular form taken by computer hardware system 20 will depend upon the manner and environment in which the system is used. Further, computer system 20 may also be configured with a cellular telephone, a global positioning system (GPS), digital camera, facsimile machine, image scanner, or FAX/Modem.

In accordance with the techniques of this disclosure, computer hardware system 20 of FIG. 1 can be used to perform a method for accounting for emergency personnel and civilians at a site using a portable information receiving device that is communicatively coupled to a computer. A user may transport portable information receiving device 39 to the site. Using portable information receiving device 39 for receiving machine-recognizable information that is associated with a person at the site and includes identification for the person, the person may log into computer hardware system 20. Computer hardware system 20 may classify, based on the identification of the person, the person as either an emergency personnel or a civilian. In response to classifying the person as a civilian, computer hardware system 20 may assigning the person to a location of the site or simply log that the person is accounted for. Computer hardware system 20 may record the location to which the person is assigned or the presence of the person.

In this way, computer hardware system 20 may extend to separating emergency personnel from civilians, providing different functionality for each classification of persons in order to adequately and efficiently manage an emergency situation. For instance, using portable information receiving device 39 for receiving a second instance of machine-recognizable information that is associated with a second person at the site and includes identification for the second person, that second person may log in to computer hardware system 20. Computer hardware system 20 may classify, based on the identification of the second person, the second person as either emergency personnel or a civilian. In response to classifying the second person as emergency personnel, computer hardware system 20 may assign the second person to a task and/or a second location of the site. Computer hardware system 20 may record the task and/or the second location to which the second person is assigned. Furthermore, computer hardware system 20 may output, for display on display monitor 33, a map that includes at least the location of the civilian, an indication of the person classified as a civilian, and an indication of one or more resources needed by the person. The one or more resources needed by the person may be included in the received machine recognizable information, and may include one or more of medical information, injury information, food information, water information, shelter information, service information, and clothing information. In that way, the emergency personnel knows exactly where they need to go and what resources they need to provide someone who is in need of assistance at that location.

A list may be loaded into computer hardware system 20, either through an internet download, a physical memory device, or manual entry. The list may include a plurality of civilian names expected to be present at the location. In response to using portable information receiving device 39 for receiving the machine-recognizable information that is associated with the person at the site, computer hardware system 20 may compare an identity of the person to the list. In response to matching the identity of the person to a first civilian name in the list, computer hardware system 20 may remove the first civilian name from the list to create an unaccounted list (e.g., the names remaining on the list after the first civilian name is removed may be the names of people who are unaccounted for at the location).

In some instance, in response to using portable information receiving device 39 for receiving the machine-recognizable information that is associated with the person at the site, computer hardware system 20 may add an identity of the person to an accounted list (e.g., a list of civilians at the site who are accounted for as being safe). In some such instances, a list may be loaded into computer hardware system 20, the list including a plurality of civilian names expected to be present at the location. Computer hardware system 20 may cross-reference the list with the accounted list to create an unaccounted list that includes civilians contained in the list but not contained in the accounted list (e.g., those expected to be at the site but who are not yet accounted for).

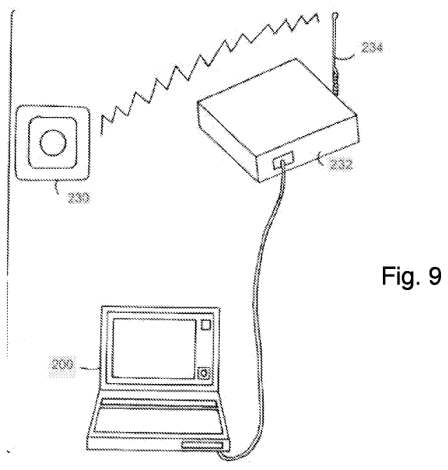

Having generally described the components for implementing the personnel accountability system of the present disclosure, reference will now be made in detail to the present preferred embodiments for implementing the present disclosure, examples of which are illustrated in FIGS. 9 through 13.

FIG. 9 shows an implementation of the present disclosure according to first embodiment wherein the I.D. tags are implemented using an RF I.D. transmitting chips 230 and the information receiving device 39 is implemented using an RF receiver 232 that is coupled to computer 200. In practice, RF I.D. transmitting chip 230 is carried by the civilian and is activated by pressing a button included thereon to transmit modulated information from its memory to an antenna 234 of receiver 232.

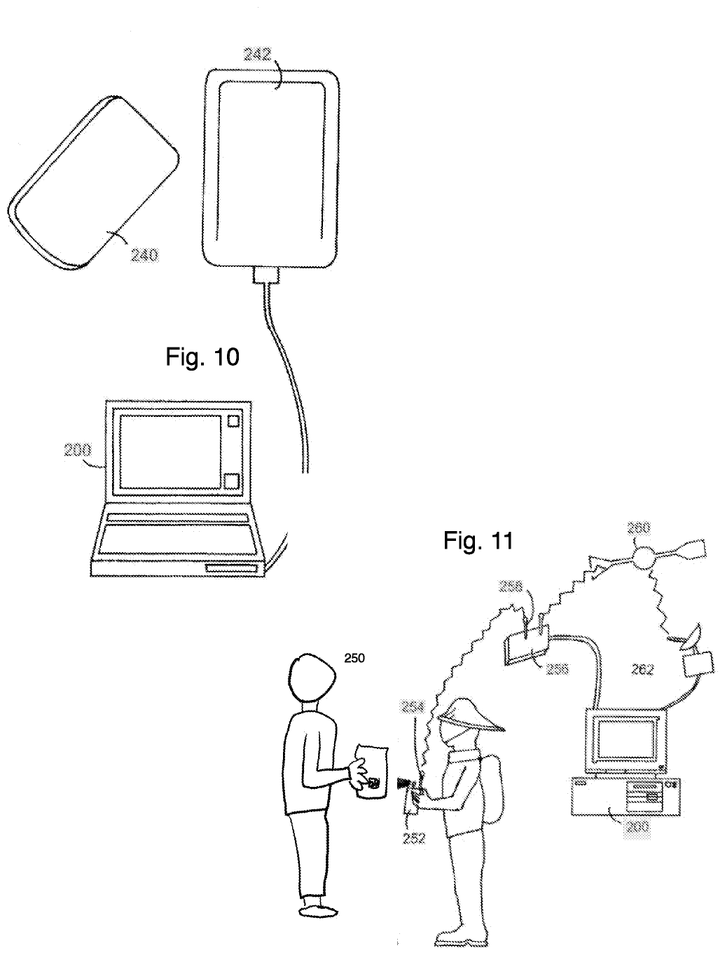

FIG. 10 shows a second embodiment of the present disclosure whereby the I.D. tags are implemented using smart cards 240 and the information receiving device 39 is implemented using a smart card reading device coupled to computer 200. A smart card 240 would be carried by the civilian and would include the civilian's identification and other information stored in the memory chip included on card 240. When arriving at the staging area, the incident commander would insert the smart card 240 into reading device 242 to read the information from the card's memory. Such smart cards and smart card reading devices are available from various manufacturers.

FIG. 11 shows a third embodiment of the present disclosure whereby the I.D. tags are implemented using one- or two-dimensional bar codes 250 and the information receiving device 39 is implemented using a portable bar code reading device 252 that is communicatively coupled to computer 200 by an RF link to a receiver 256 that is coupled to computer 200 by either a cable or via a satellite 260 and a satellite receiver 262. With this implementation, an incident commander may read a bar code 250 using reader 252 in a location remote from computer 200. When the data is read from bar code 250, portable reading device 252 translates the information read into an electrical signal that is modulated onto an RF carrier signal and transmitted through antenna 254 to an antenna 258 of receiver 256. Receiver 256 may demodulate the received signal and provide it over the cable to computer 200 or it may relay the signal to a satellite 260 that, in turn, relays the information to a satellite receiver 262 attached by cable to computer 200. The embodiment shown in FIG. 13 may provide several advantages in that the computer system 200 need not be portable and/or need not be provided separately at each location where a reading device is used. Further, by providing a satellite link between the receiver 256 and computer 200, computer 200 may be maintained at a central location. It will be appreciated by those skilled in the art, that this satellite link between an information receiving device 39 and the computer 200 may be used in any of the other described embodiments.

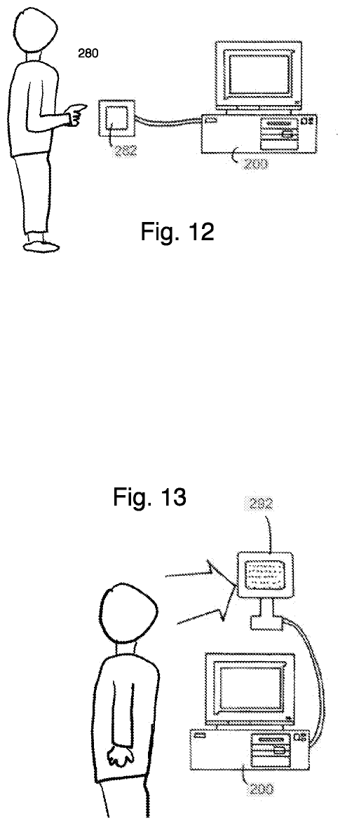

FIG. 12 shows an fourth embodiment of the present disclosure whereby the I.D. tags are implemented using electronic I.D. tags provided in electrical contact with the civilians's body and in which the information receiving device 39 is implemented using a touch receiver 282 coupled to a computer 200. In operation, when the civilian reports to a staging area, the civilian touches touch receiver 282 to provide a conduit path for the information stored in electronic I.D. tag 280 to be read by touch receiver 282 and relayed to computer 200.

FIG. 13 shows a fifth embodiment of the present disclosure whereby the information receiving device 39 is implemented using a microphone 292 coupled to a voice recognition board provided within a computer 200. In this implementation, the I.D. tags may be eliminated by having the civilian provide identification and/or other information to computer 200 by speaking into microphone 292.

It will be appreciated by those skilled in the art that various features of the above embodiments may be combined and that the systems used in these embodiments may take various forms. For example, as will be understood from the following description of but one application of the above-described embodiments, more than one information receiving device may be coupled to computer 200. Further, in each of the various implementations of the I.D. tags described above, the information stored in the tags and received by the information receiving device 39 may include a civilians' identification information as well as other information pertaining to that civilian, such as the civilian's qualification information.

Although the above embodiments may be used in many different applications and environments, the following description of the application of these embodiments for use by civilian's is provided to illustrate but one of the possible applications in some detail.

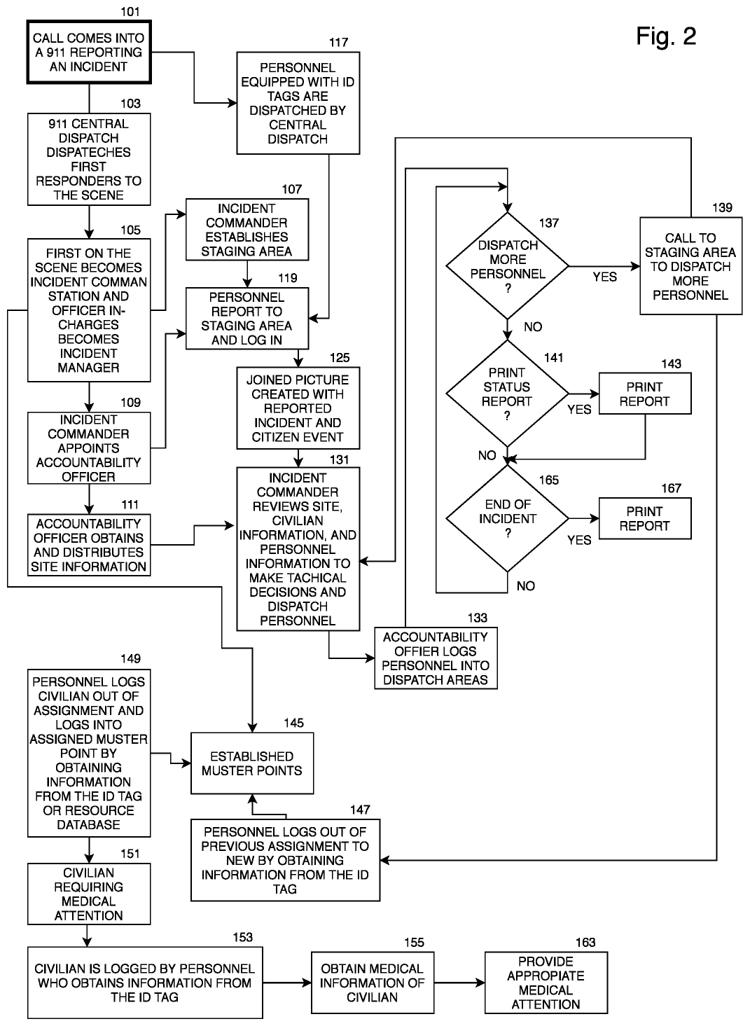

FIG. 2 illustrates one example of the overall flow of events that would typically occur at the scene of an emergency when the civilian accountability system of the present disclosure is implemented. The first event typically occurring is a call to 911 reporting an emergency or incident (step 101). Upon receiving a call, the 911 central dispatch dispatches first responders to the scene (step 103). The first dispatched vehicle arriving at the scene assumes the role as the incident command station and the officer-in-charge of the first emergency vehicle becomes the incident commander (step 105). The incident commander's first tasks are to establish a staging area (step 107) and to appoint an accountability officer (step 109). The accountability officer obtains and distributes site information that may be stored in a block of machine-readable data located in a nearby lockbox or that may be remotely transmitted to information receiver 39 or some other receiver used with the system from a location associated with the site (step 111).

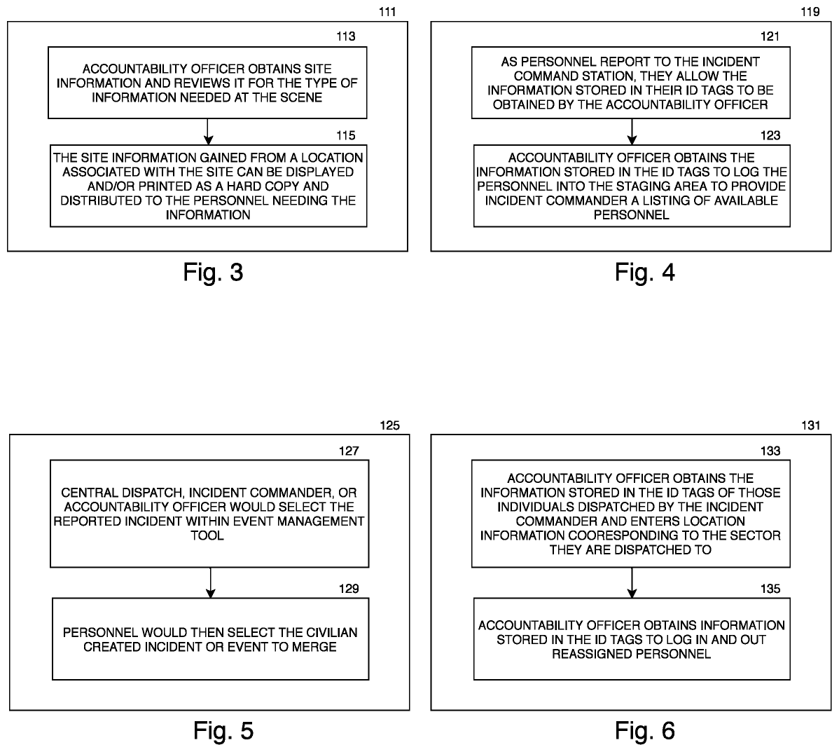

The manner by which the accountability officer obtains and distributes site information is illustrated in the flow chart shown in FIG. 3.

After the accountability officer has obtained all the site information, the accountability officer may print out hard copies of any of the site information for distribution to the personnel needing the information (step 115). Thus, first responders arriving at the scene of an emergency may greatly benefit by having access to site information they otherwise could not have obtained. Site information of the nature discussed above greatly improves first responders' efficiency in resolving the situation.

In addition to dispatching first responders to the scene, the 911 central dispatch also dispatches personnel to the scene by calling them on radios (step 117). The dispatched personnel can be already be equipped with an I.D. tag and at least one medical information tag that each include some form of storage medium from which stored data may be transferred to data receiver 39. The information contained on these I.D. tags can include a first responder's name, battalion or unit, levels of completed training, and qualifications. The medical information tags can include the individual medical history, such as allergy information, medications being taken, hospital preference, insurance information, doctor's name and telephone number, and a list of individuals to contact in case of an emergency.

As the personnel arrive at the scene, they report to the staging area to log into the system (step 119). FIG. 4 illustrates the manner by which personnel are logged into the system. At the staging area, the arriving personnel allow the information stored in their I.D. tags to be obtained by the accountability officer (step 121). The accountability officer then uses the information obtained from the I.D. tags to log in personnel into the staging area, thus compiling a listing of the personnel available for dispatch (step 123).

Referring back to FIG. 2 (step 125), the central dispatch, incident commander, or accountability officer, would join the reported incident with the civilian event where a selection is made to select the reported incident within the event management too (step 127). The personnel would then select the civilian created incident or event to merge (step 129). FIG. 5. Illustrates the manner in which two incidents are joined.

Referring back to FIG. 2, the incident commander now has available site information, which is a compilation of all the interior locations of things that are in the building that a first responder needs to know, such as where the shut-offs are, the gas and the water are, where the elevators are, who to contact in case of an emergency, where the high value salvage areas are, where the hazardous materials are and how much of it is there, fire inspection reports, MSDS, Tier-Two reports, site drawings of the building and photographs of the interior, and has a listing of the personnel available for dispatch that includes the level of training and experience of each of the available personnel. The first responder also has the visibility of all the civilians on-site. All of this is in one common operating picture. Having all this information available, the incident commander can make informed tactical decisions defuse the situation. Moreover, by having the site information, the incident commander can actually use this information to direct first responders towards civilians to defuse the situation faster.

After the incident commander has made a decision to dispatch a particular person to a particular area of the site, the accountability officer logs that person into the assigned area (step 133). FIG. 6 illustrates the manner by which personnel are logged into or out of a particular area by the accountability officer. First, the accountability officer obtains the information stored in the I.D. tag of those first responders dispatched by the incident commander to a particular sector and then enters location information into the system identifying the particular sector to which the first responders are dispatched (step 133). After the personnel are assigned to an assignment, they may be reassigned to another sector or logged out of the sector by the accountability officer who enters the information stored on their I.D. tags (step 135).

Returning to FIG. 2, at any time additional personnel need to be or are available to be dispatched (step 137), a call may be placed to the staging area to dispatch more personnel (step 139).

Further, should the incident commander wish to review an up-to-date status report (step 141), he can print a report at any time including the current assignment status of all personnel on-scene, where they are, what they are trained to do, and their log in times (step 143).

Another task performed by the incident commander is to establish points of refuge (muster points) for civilians (step 145). These may already be assigned by the business, organization or schools and advertised accordingly. Incident commander would need to add personnel to these for accountability. To assign personnel to muster points, personnel can scan personnel's ID badge or reassign with accountability solution, which logs them out of their previous assignment and then into the assigned muster point (step 147). Thus, when a situation arises and civilians know the meeting place/muster point for accountability, personnel scan the ID badge of the civilian which logs them to that assignment (step 149).

Should civilians require medical attention (step 151), the civilian would have their information accessed by having their I.D. tag read into the system (step 153). This procedure may be carried out by medical personnel, so that the accountability officer may log the person requiring medical attention out of their assignment. The medical personnel may then immediately obtain the person's medical information by reading the information stored in one of the medical information barcodes on the I.D. tag (step 155).

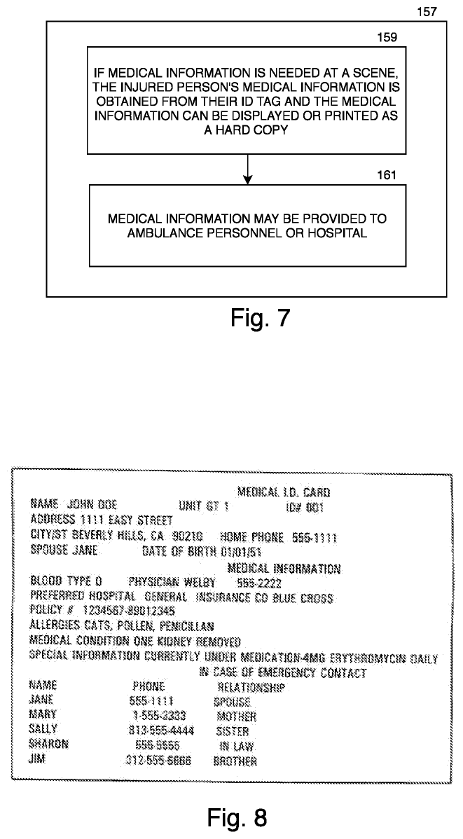

The manner by which the medical personnel obtain this medical information is illustrated in FIG. 7 (step 157). After obtaining the medical information from the medical tag, the medical personnel may display the obtained information on a display monitor or print out a hard copy of this information (step 159). FIG. 8 shows an example of a display screen or report including the medical information that may be contained in a bar code. This medical information may then be handed to ambulance personnel or to personnel at a hospital (step 161). Because seconds may mean the difference between life or death for an injured civilian, immediate access to medical information may be crucial. By placing the medical record on the civilian, medical personnel may immediately obtain the civilian's medical record, and give the prognosis and medical records to the hospital over the radio or via other suitable means. Thus, the medical information will be readily available so that immediate medical attention may be given to the injured civilian (step 163). Additionally, upon arrival at the hospital, the civilian may be immediately admitted to the emergency room without experiencing the routine delay typically encountered when such medical information is required before admittance.

After the situation has been resolved, a report may be printed to fully reconstruct the deployment of personnel including which personnel were dispatched, where the personnel were dispatched, and the time each person spent in each area as well as all civilians and their logged whereabouts at all times (steps 165 and 167).

Although the above example has been described with respect to deployment of both personnel and civilians at the scene of an emergency, it will be appreciated that the civilian accountability system of the present disclosure may be employed to track any type of civilians and that the present disclosure is particularly suited for tracking citizens, students, staff, employees, managers, and leadership. In such applications, the information contained in the I.D. tags would vary to suit the needs for each different application.

Additionally, although the above example refers to the use of the system of the present disclosure to assign civilians to a particular sector of an emergency site, the system could be used to assign non-location specific tasks based upon the person's qualifications and to account for civilians at any other form of non-emergency site, school location, or work site.

Further, although various specific implementations have been described for presenting machine-readable data, other forms of machine-readable data, such magnetic strips, or machine-readable data implemented using sonic or optical character recognition (OCR) technologies, or the like may also be used to practice the present disclosure.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method for accounting for emergency personnel and civilians at a site using a portable information receiving device that is communicatively coupled to a computer, the method comprising:
transporting the portable information receiving device to the site;
using the portable information receiving device for receiving machine-recognizable information that is associated with a person at the site and includes identification for the person, in order to log that person into the computer;
classifying, based on the identification of the person, the person as either an emergency personnel or a civilian;
in response to classifying the person as a civilian, assigning the person to a location of the site; and
recording, in the computer, the location to which the person is assigned.

2. The method of claim 1, wherein the information receiving device includes an RF receiver and the machine-recognizable information is stored in a memory device of an RF transmitter carried by the person, and wherein the information is transmitted in an RF signal to the RF receiver.

3. The method of claim 2, wherein the step of receiving the machine-recognizable information is initiated by actuating a button on the RF transmitter.

4. The method of claim 2, wherein the step of receiving the machine-recognizable information is initiated when the person carrying the RF transmitter comes into near proximity an antenna of the RF receiver.

5. The method of claim 2, wherein the step of receiving the machine-recognizable information is initiated by transmitting an interrogation signal to a receiver coupled to the RF transmitter, which responds by transmitting an RF signal including the information to the RF receiver.

6. The method of claim 1, wherein the information receiving device includes a touch-sensitive receiver and the machine-recognizable information is stored in a memory device carried by the person.

7. The method of claim 6, wherein the memory device is carried in electrical contact with the person's body and the step of receiving the machine-recognizable information is performed by the personnel touching the touch-sensitive receiver.

8. The method of claim 6, wherein the memory device is a touch memory button and the step of receiving the machine-recognizable information is performed by the touching the touch memory button with the touch-sensitive receiver.

9. The method of claim 1, wherein the information receiving device includes a card reading device and the machine-recognizable information is stored in a memory device of a card carried by the person.

10. The method of claim 1, wherein the information receiving device includes an infrared receiver and the machine-recognizable information is stored in a memory device of an infrared transmitter carried by the person, and is transmitted in an infrared signal to the infrared receiver.

11. The method of claim 1, wherein the information receiving device includes a microphone coupled to a voice recognition device and the step of receiving the machine-recognizable information is performed by the person speaking into the microphone.

12. The method of claim 1, wherein the information receiving device includes a bar code reader and the machine-recognizable information is stored in a bar code carried by the personnel.

13. The method of claim 12, wherein the bar code reader includes a transmitter for transmitting data read from the bar code to a receiver coupled to the computer.

14. The method of claim 13, wherein the receiver is coupled to the computer via a satellite link.

15. The method of claim 1, further comprising:
using the portable information receiving device for receiving a second instance of machine-recognizable information that is associated with a second person at the site and includes identification for the second person, in order to log the second person into the computer;
classifying, based on the identification of the second person, the second person as either emergency personnel or a civilian;
in response to classifying the second person as emergency personnel, assigning the second person to a task and/or a second location of the site; and
recording, in the computer, the task and/or the second location to which the second person is assigned.

16. The method of claim 15, further comprising:
outputting, by the computer and for display on a display device, a map that includes at least the location, an indication of the person classified as a civilian, and an indication of one or more resources needed by the person.

17. The method of claim 1, further comprising:
loading, into the computer, a list comprising a plurality of civilian names expected to be present at the location;
in response to using the portable information receiving device for receiving the machine-recognizable information that is associated with the person at the site, comparing an identity of the person to the list; and
in response to matching the identify of the person to a first civilian name in the list, removing the first civilian name from the list to create an unaccounted list.

18. The method of claim 1, wherein the machine recognizable information further includes one or more resources needed by the person,
wherein the one or more resources comprise one or more of:
medical information,
injury information,
food information,
water information,
shelter information,
service information, and
clothing information.

19. The method of claim 1, further comprising:
in response to using the portable information receiving device for receiving the machine-recognizable information that is associated with the person at the site, adding an identity of the person to an accounted list.

20. The method of claim 19, further comprising:
loading, into the computer, a list comprising a plurality of civilian names expected to be present at the location; and
cross-referencing the list with the accounted list to create an unaccounted list comprising civilians contained in the list but not contained in the accounted list.
